(19) United States
(12) Patent Application Publication
(10) Pub. No.: US 2011/0228579 A1
(43) Pub. Date: Sep. 22, 2011

(54) Adjustable Frequency Generator and Related Power Supply

(76) Inventors: Chin-Yen Lin, Hsinchu County (TW); Min-Chu Chien, Hsinchu County (TW); Fu-Yuan Chen, Kao-Hsiung Hsien (TW)

(21) Appl. No.: 12/904,172

(22) Filed: Oct. 14, 2010

Related U.S. Application Data
(60) Provisional application No. 61/314,552, filed on Mar. 16, 2010.

(51) Int. Cl. H02M 5/44

(52) U.S. Cl. 363/163

(57) ABSTRACT

An adjustable frequency generator for a power supply is disclosed. The adjustable frequency generator comprises a waveform generator, a voltage generator and a comparator. The waveform generator is used for generating a saw wave. The voltage generator is used for generating a variable upper reference voltage and a variable lower reference voltage according to variation of a load. The comparator is coupled to the waveform generator and the voltage generator and used for comparing the saw wave with the variable upper reference voltage and the variable lower reference voltage and generating an output signal. A frequency of the output signal decreases when the load becomes lighter.

### CROSS REFERENCE TO RELATED APPLICATIONS

This application claims the benefit of U.S. Provisional Application No. 61/314,552, filed on Mar. 16, 2010 and entitled “ADJUSTABLE FREQUENCY GENERATOR FOR POWER SUPPLY” the contents of which are incorporated herein.

### BACKGROUND OF THE INVENTION

1. Field of the Invention

The present invention relates to an adjustable frequency generator for a power supply, and more particularly, to an adjustable frequency generator varying its frequency with a load and a related power supply.

2. Description of the Prior Art

Power supplies, converting an AC mains voltage to a DC voltage, are wildly used in integrated electronic devices. The power supplies are required to maintain the output voltage, current or power within a regulated range for efficient and safe operation of the electronic device, and thus a switched mode power supplies are commonly used due to their high efficiency and good output regulation to power many of today's electronic device. In the switched mode power supplies, the energy flow is controlled by a switch, that are continuously switching on and off at high frequency. The switched mode power supply offer greater efficiency compared with a linear supply because the switch can control energy flow with low losses. When the switch is on, it has low voltage drop and will pass any current impose on it. When the switch is off, it blocks the flow of current. As a result, the power dissipation can be relatively low in both states.

In the switched mode power supplies, a pulse width modulation (PWM) controller is used to control the output power and achieve the regulation. An “ON” and “OFF” duration of the switch are controlled by a duty cycle of the output of the PWM controller. The duty cycle is controlled by an operation frequency of the PWM controller. An adjustable frequency generator is usually used for providing the operation frequency for the PWM controller. In order to improve the efficiency and reduce losses, the PWM controller should adjust its output according to the load condition. Namely, when there is a large load at the output of the switched mode power supply, the duty cycle is increased. When the load becomes lighter, the duty cycle is decreased.

With respect to power management when the load is light or removed, some documents described below disclose method and related PWM controller to vary the duty cycle with the load condition.

U.S. Pat. No. 6,212,079 discloses a method and apparatus for improving efficiency in a switching regulator at light loads. The switching regulator operates at a frequency for a first range of feedback signal values and at an adjustable frequency without skipping cycles for a second range of feedback signal values.

U.S. Pat. No. 6,545,882 discloses PWM controller having OFF-TIME modulation for power converter. The OFF-TIME modulation in the PWM controller is provided to increase the switching period for saving power consumption in the light load and no load conditions. The OFF-TIME modulation is achieved by keeping the charge current as a constant and moderating the discharge current of the saw-tooth-signal oscillator of the PWM controller.

U.S. Pat. No. 6,100,675 discloses a switching regulator capable of increasing regulator efficiency under light load. The efficiency of the switching regulator is increased while the switching regulator is operated under low load condition.

The abovementioned US patents all disclose a way of improving efficiency and reducing power consumption for the power supply at the low load or no load condition.

### SUMMARY OF THE INVENTION

It is therefore an objective of the present invention to provide an adjustable frequency generator for a power supply to adjust an output frequency of the adjustable frequency generator according to variation of a load of the power supply.

The present invention discloses an adjustable frequency generator for a power supply. The adjustable frequency generator comprises a waveform generator, a voltage generator and a comparator. The waveform generator is used for generating a saw wave. The voltage generator is used for generating a variable upper reference voltage and a variable lower reference voltage according to variation of a load. The comparator is coupled to the waveform generator and the voltage generator and used for comparing the saw wave with the variable upper reference voltage and the variable lower reference voltage and generating an output signal. A frequency of the output signal decreases when the load becomes lighter.

The present invention further discloses an adjustable frequency generator for a power supply. The adjustable frequency generator comprises a waveform generator, a voltage generator and a comparator. The waveform generator is used for generating a saw wave according to variation of a load of the power supply and comprises a variable capacitor. The variable capacitor is used for adjusting capacitance of the variable capacitor according to the variation of the load and storing or releasing electrical charges to generate the saw wave. The voltage generator is used for generating an upper reference voltage and a lower reference voltage. The comparator is coupled to the waveform generator and the voltage generator, and used for comparing the saw wave with the upper reference voltage and the lower reference voltage and generating an output signal. A frequency of the output signal decreases when the load becomes lighter.

The present invention further discloses an adjustable frequency generator for a power supply. The adjustable frequency generator comprises a waveform generator, a voltage generator and a comparator. The waveform generator is used for generating a saw wave and comprises a first current source, a second current source, a charge switch, a discharge switch and a capacitor. The first current source is used for providing a charge current. The second current source is used for providing a discharge current. The charge switch is coupled to the first current source and used for turning on/off according to the output signal. The discharge switch is coupled to the second current source and the inverter and used for turning on/off according to the inverted output signal. The capacitor is coupled to the charge switch and the discharge switch and used for storing or releasing electrical charges to generate the saw wave. The voltage generator is used for generating an upper reference voltage and a lower reference voltage. The comparator is coupled to the waveform generator and the voltage generator, and used for comparing the saw wave with the upper reference voltage and the lower reference voltage and generating a comparison result. The delay unit is coupled to the comparator for delaying a period of the comparison result a delay time according to variation of a load of the power supply to generate an output signal. A frequency of the output signal decreases when the load becomes lighter.

The present invention further discloses a power supply. The power supply comprises a load, a transformer, a pulse width modulation (PWM) controller and an adjustable frequency generator. The transformer comprises a primary winding and a secondary winding. The primary winding is used for generating a feedback signal in response to variation of the load. The secondary winding is coupled to the load and used for providing an output current. The PWM controller is coupled to the primary winding and used for controlling the output current according to the feedback signal. The adjustable frequency generator is coupled to the PWM controller and used for generating an output signal to the PWM controller according to the feedback signal. A frequency of the output signal decreases when the load becomes lighter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a power supply according to an example.

FIG. 1B is a schematic diagram of a power supply according to another example.

FIG. 2 is a schematic diagram of an adjustable frequency generator according an example.

FIG. 3 is a schematic diagram of an adjustable frequency generator according to an example.

FIG. 4 illustrates the relationship between a load and an output signal.

FIG. 5 is a schematic diagram of an adjustable frequency generator according to an example.

FIG. 6 illustrates various signal waveforms of the adjustable frequency generator shown in FIG. 5.

FIG. 7 is a schematic diagram of an adjustable frequency generator according to another example.

FIG. 8 illustrates various signal waveforms of the adjustable frequency generator shown in FIG. 7.

FIG. 9 illustrates a load versus a frequency.

FIGS. 10-12 illustrates loads versus frequencies according to different examples.

### DETAILED DESCRIPTION

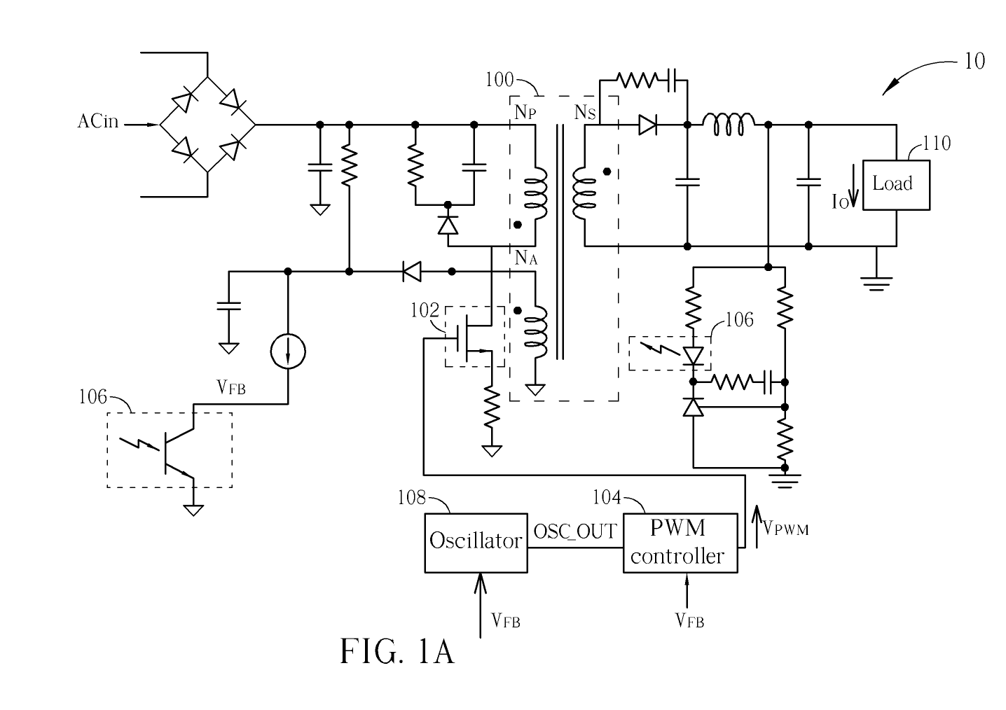

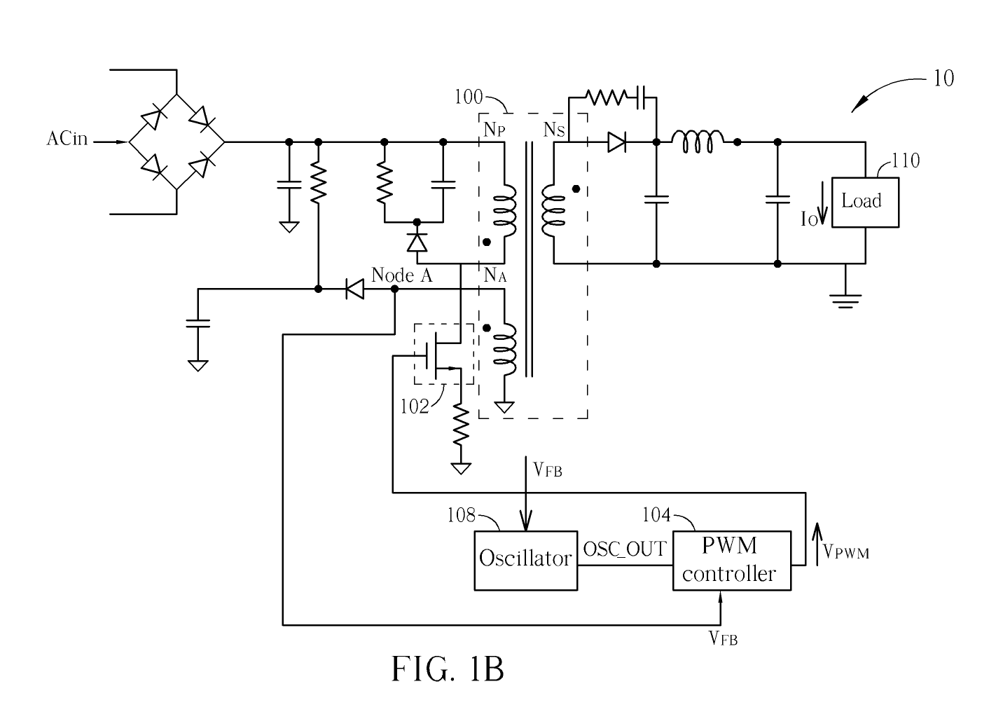

Please refer to FIG. 1A, which is a schematic diagram of a power supply 10. Generally, the power supply 10 includes a transformer 100, a transistor 102, a pulse width modulation (PWM) controller 104, an opto-coupler 106, an adjustable generator 108, and a load 110. Preferably, the power supply 10 may be referred as to a switched mode power supply. The PWM controller 104 generates a switching signal V_{PWM} for switching the transformer 100 via the transistor 102. A duty cycle of the switching signal V_{PWM} determines the power delivered from a primary winding N_{P} to a second winding N_{S} of the transformer 100, thereby generating the secondary DC voltage. In order to keep the secondary DC voltage within a regulated range, a feedback loop including the opto-coupler 106 provides a feedback voltage V_{FB} to vary the duty cycle of the switching signal V_{PWM}. According to condition of the load 110, the adjustable frequency generator 108 is used for generating an output signal OSC_OUT as an operation frequency of the PWM controller 104. The frequency of the output signal OSC_OUT varies with the load 110. When the load 110 decreases, the adjustable frequency generator 108 decreases the frequency of the output signal OSC_OUT. When the load 110 increases, the adjustable frequency generator 108 increases the frequency of the output signal OSC_OUT. Therefore, when the load 110 is light or there is no load at the DC output of the power supply 10, the adjustable frequency generator 108 decreases the frequency of the output signal OSC_OUT, avoiding frequent switching of the transistor 102. As a result, decreasing the frequency of the output signal OSC_OUT reduces switching losses and improves efficiency. In some example, the opto-coupler 106 could be removed. Please refer to FIG. 1B, which is a schematic diagram of a power supply 10 according to another example. The same reference numbers designated in FIG. 1A and FIG. 1B indicate identical or functionally similar elements. Thus, the detailed description can be found above, and omitted herein. The differences between FIG. 1A and FIG. 1B are that the opto-coupler 160 is removed in FIG. 1B and the feedback voltage V_{FB} is directly drawn from a node A. The power supplies with/without the opto-coupler 106 are both considered within the scope of the present invention.

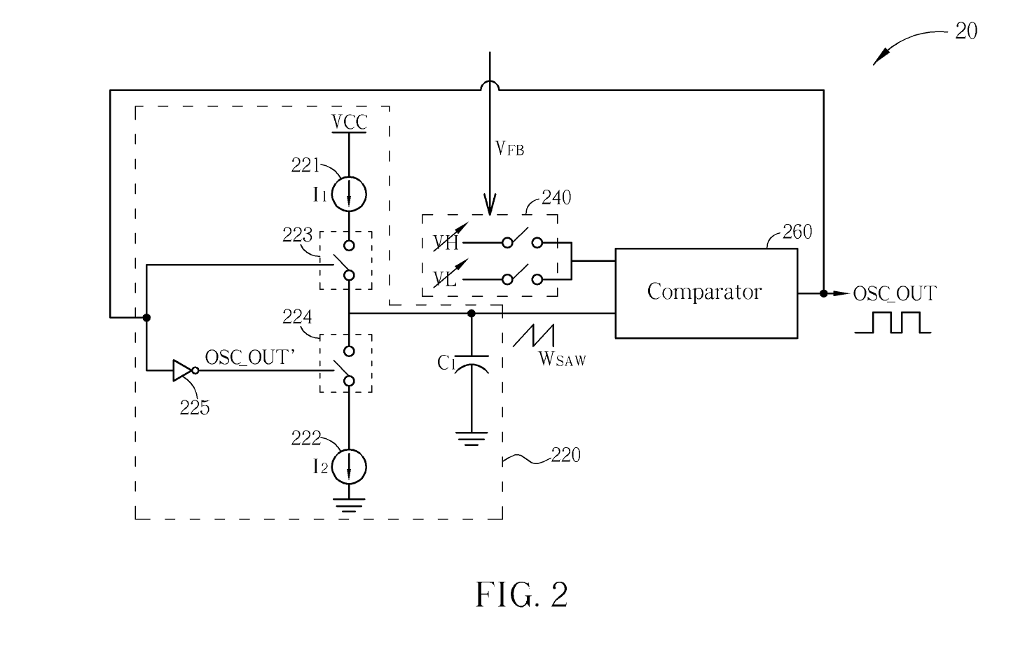

Please refer to FIG. 2, which is a schematic diagram of an adjustable frequency generator 20 according an example of the present invention. The adjustable frequency generator 20 could be the adjustable frequency generator 108 shown in FIG. 1A or the adjustable frequency generator 108 shown in FIG. 1B, aiming to generate an adjustable frequency as an operation frequency of the PWM controller 104. The adjustable frequency generator 20 includes a waveform generator 220, a voltage generator 240 and a comparator 260. The waveform generator 220 is coupled to the comparator 260 and used for generating a saw wave W_{SAW} to the comparator 260 and retrieving a feedback from the output of the comparator 260. The waveform generator 220 includes a first current source 221, a second current source 222, a charge switch 223, a discharge switch 224, an inverter 225 and a capacitor C1. The first current source 221 and the second current source 222 are constant current sources and utilized for providing a charge current I1 and a discharge current I2, respectively. The inverter 225 generates an inverted output signal OSC_OUT′ by inverting the output signal OSC_OUT. Thus, the output signal OSC_OUT and the inverted output signal OSC_OUT′ have opposite phases. The charge switch 223 and the discharge switch 224 are shorted alternatively by the output signal OSC_OUT and the inverted output signal OSC_OUT′. The capacitor C1 has a fixed capacitance value and is then charged by the charge current I1 via the charge switch 223 and discharged by the discharge current I2 via the discharge switch 224 to generate the saw wave W_{SAW}. The voltage generator 240 is coupled to the waveform generator 220 and the comparator 260, and used for generating a variable upper reference voltage VH and a variable lower reference voltage VL according to the feedback voltage V_{FB}. Further, the feedback voltage V_{FB} can reflect the load condition, so the variable upper reference voltage VH and the variable lower reference voltage VL vary with load condition. The comparator 260 is coupled to the voltage generator 240 and the waveform generator 220. The comparator 260 generates the output signal OSC_OUT by comparing the saw wave W_{SAW} with the variable upper reference voltage VH and the variable lower reference voltage VL. Then, the output signal OSC_OUT is fed back to the waveform generator 220. When the load (e.g. the load 110) becomes lighter or is removed, the difference between the variable upper reference voltage VH and the variable lower reference voltage VL varies increasingly, causing that the frequency of the output signal OSC_OUT is decreased. Since the frequency of the output signal OSC_OUT becomes lower, this makes the transistor 102 switch more infrequently. Consequently, the switching losses can be reduced.

In addition, when the load (e.g. the load 110) increases, the adjustable frequency generator 20 decreases the difference between the variable upper reference voltage VH and the variable lower reference voltage VL.

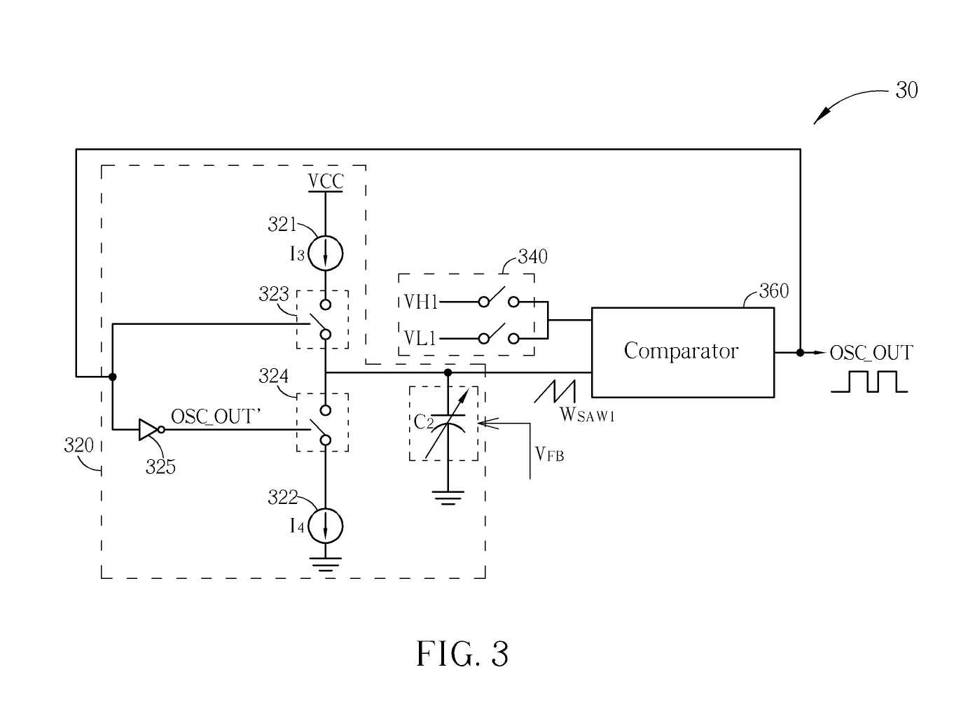

In some example, the adjustable frequency generator 108 may be implemented by a variable capacitor to generate the output signal OSC_OUT varying with the load 110. Please refer to FIG. 3, which is a schematic diagram of an adjustable frequency generator 30 according to an example. The adjustable frequency generator 30 could be the adjustable frequency generator 108 shown in FIG. 1. The adjustable frequency generator 30 includes a waveform generator 320, a voltage generator 340 and a comparator 360. The waveform generator 320 is coupled to the comparator 360 and used for generating a saw wave W_{SAW1} to the comparator 360 and retrieving a feedback from the output of the comparator 360. The waveform generator 320 includes a third current source 321, a forth current source 322, a charge switch 323, a discharge switch 324, an inverter 325 and a variable capacitor C2. Similar to the first current source 221 and the second current source 222, the third current source 321 and the forth current source 322 are utilized for providing a charge current I3 and a discharge current I4, respectively. The inverter 325 generates an inverted output signal OSC_OUT′ by inverting an output signal OSC_OUT. Likewise, the output signal OSC_OUT and the inverted output signal OSC_OUT′ have opposite phases. The charge switch 323 and the discharge switch 324 are shorted alternatively by the output signal OSC_OUT and the inverted output signal OSC_OUT′. The variable capacitor C2 is then charged by the charge current I3 via the charge switch 323 and discharged by the discharge current I4 via the discharge switch 324 to generate the saw wave W_{SAW1}. The capacitance of the variable capacitor C2 is adjusted according to the feedback voltage V_{FB}. Further, the feedback voltage V_{FB} can reflect the load condition, so the saw wave W_{SAW1} varies with the load 110. The voltage generator 340 is coupled to the waveform generator 320 and the comparator 360, and used for generating a fixed upper reference voltage VH1 and a fixed lower reference voltage VL1. The comparator 360 is coupled to the voltage generator 340 and the waveform generator 320 and generates the output signal OSC_OUT by comparing the saw wave W_{SAW1} with the fixed upper reference voltage VH1 and the fixed lower reference voltage VL1. Then, the output signal OSC_OUT is fed back to the waveform generator 320. When the load 110 becomes lighter or is removed, the capacitance of the variable capacitor C2 is increased accordingly. This makes the rising time of the saw wave W_{SAW1} longer and makes the frequency of the output signal OSC_OUT be decreased. By the same token, the switching losses can be reduced as well. In addition, when the load 10 becomes heavier, the capacitance of the variable capacitor C2 is decreased accordingly.

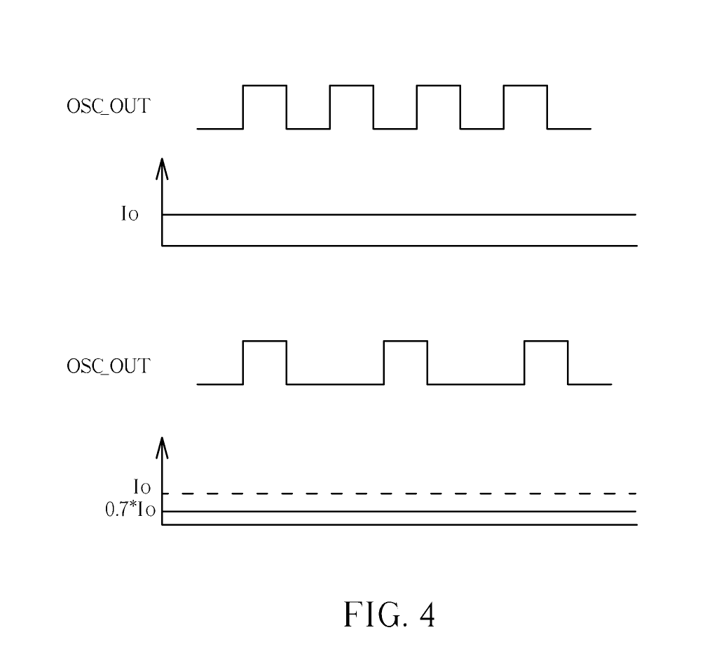

Please refer to FIG. 4, which illustrates the relationship between the load 110 and the output signal OSC_OUT. In some examples, the load can be carrier out by a resistor. Therefore, the output current Io flowing through the resistor can determine the load condition (light or heavy). As shown in FIG. 4, when the output current Io become smaller (0.7Io), the frequency of the output signal is decreased

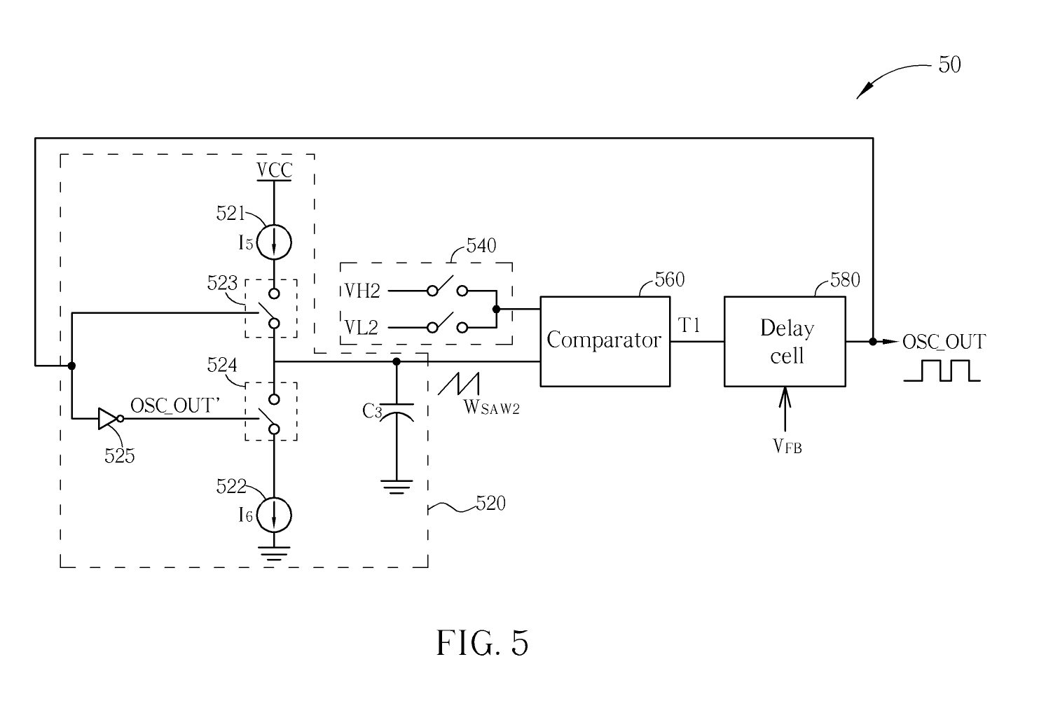

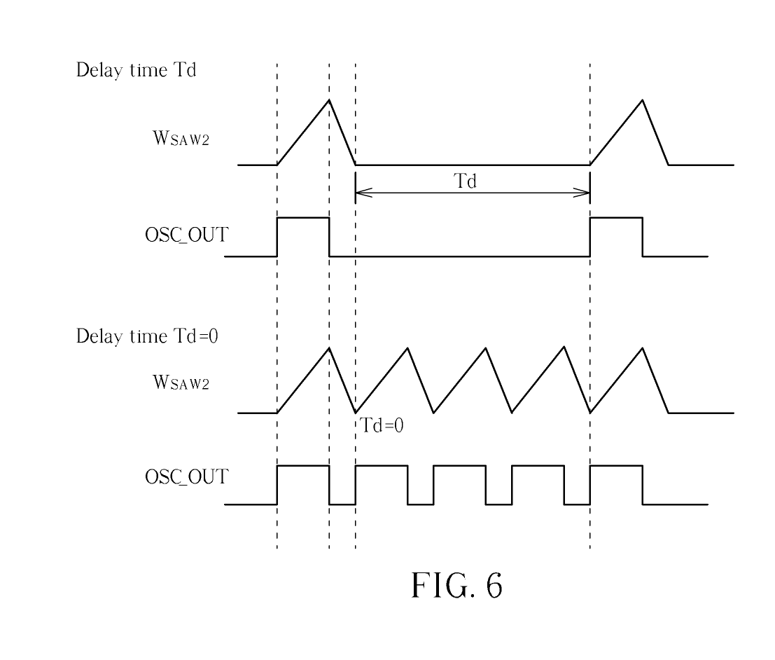

In some example, the adjustable frequency generator 108 may be implemented by a delay cell to generate the output signal OSC_OUT varying with the load 110. Please refer to FIG. 5, which is a schematic diagram of an adjustable frequency generator 50 according to an example. The adjustable frequency generator 50 could be the adjustable frequency generator 108 shown in FIG. 1. The adjustable frequency generator 50 includes a waveform generator 520, a voltage generator 540 and a comparator 560 and a delay cell 580. The waveform generator 520 is coupled to the comparator 560 and the delay cell 580 and used for generating a saw wave W_{SAW2} to the comparator 560 and retrieving a feedback from the output of the delay cell 580. The waveform generator 520 includes a fifth current source 521, a sixth current source 522, a charge switch 523, a discharge switch 524, an inverter 525 and a capacitor C3. The fifth current source 521 and the sixth current source 522 are utilized for providing a charge current I5 and a discharge current I6, respectively. The inverter 525 generates an inverted output signal OSC_OUT′ by inverting an output signal OSC_OUT. Likewise, the output signal OSC_OUT and the inverted output signal OSC_OUT′ have opposite phases. The charge switch 523 and the discharge switch 524 are shorted alternatively by the output signal OSC_OUT and the inverted output signal OSC_OUT′. The capacitor C3 has a fixed capacitance and is charged by the charge current I5 via the charge switch 523 and discharged by the discharge current I6 via the discharge switch 524 to generate the saw wave W_{SAW2}. The voltage generator 540 is coupled to the waveform generator 520 and the comparator 560, and used for generating a fixed upper reference voltage VH2 and a fixed lower variable reference voltage VL2. The inputs of the comparator 560 are coupled to the voltage generator 540 and the waveform generator 520. The comparator 560 compares the saw wave W_{SAW2} with the upper reference voltage VH2 and the lower reference voltage VL2 and generates a comparison result T1. The output of the comparator 560 is coupled to the delay cell 580. The comparator 560 outputs the comparison result T1 to the delay cell 580. The delay cell 580 is coupled to the comparator 560, and used for generating the output signal OSC_OUT by delaying the comparison result T1 for a delay time T_{d} according to the feedback voltage V_{FB}. Then, the output signal OSC_OUT is fed back to the waveform generator 520. Since the output of the comparator 560 is delayed for the delay time T_{d} (the period of the output signal OSC_OUT is increased), the frequency of the output signal OSC_OUT is decreased. Further the feedback voltage V_{FB} can reflect the load condition. That is, the adjustable frequency generator 50 may vary the delay time T_{d} with the load condition. When the load 110 becomes lighter or is removed, the delay time T_{d} is increased accordingly. This makes the frequency of the output signal OSC_OUT be decreased. By the same token, the switching losses can be reduced as well. Please refer to FIG. 6, which illustrates various signal waveforms of the adjustable frequency generator 50. As shown in FIG. 6, when the delay time T_{d} increases, the frequency of the output signal OSC_OUT decreases. When the delay time T_{d} is 0, the frequency of the output signal OSC_OUT is not changed.

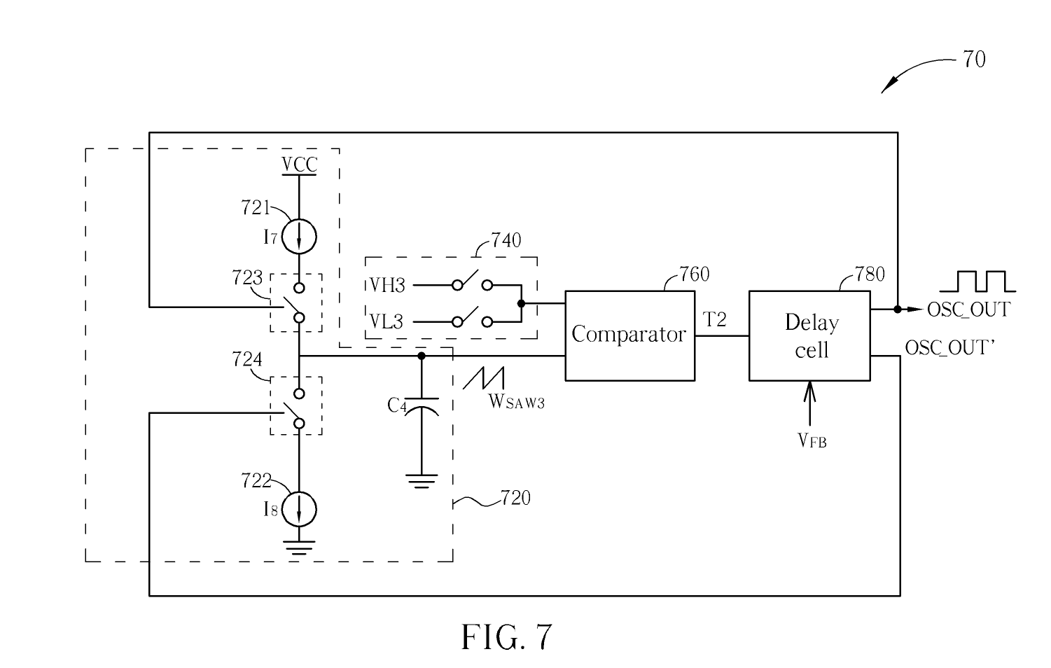

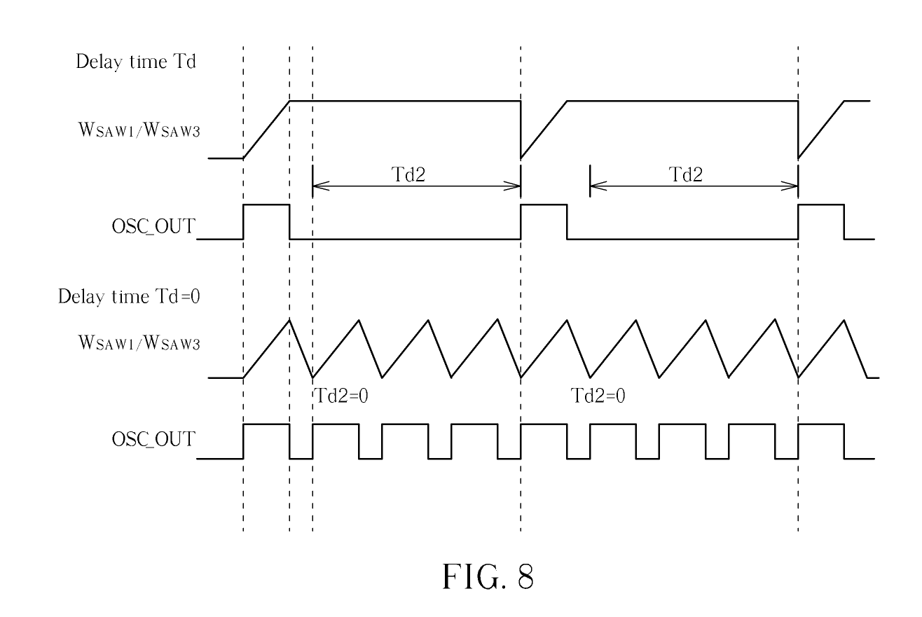

Please refer to FIG. 7, which is a schematic diagram of an adjustable frequency generator 70 according to another example. The adjustable frequency generator 70 could be the adjustable frequency generator 108 shown in FIG. 1. The adjustable frequency generator 70 includes a waveform generator 720, a voltage generator 740 and a comparator 760 and a delay cell 780. The waveform generator 720 is coupled to the comparator 760 and the delay cell 780 and used for generating a saw wave W_{SAW3} to the comparator 760 and retrieving a feedback from the output of the delay cell 780. The waveform generator 720 includes a seventh current source 721, an eighth current source 722, a charge switch 723, a discharge switch 724, and a capacitor C4. The seventh current source 721 and the eighth current source 722 are utilized for providing a charge current I7 and a discharge current I8, respectively. The capacitor C4 has a fixed capacitance and is charged by the charge current I7 via the charge switch 723 and discharged by the discharge current I8 via the discharge switch 724 to generate the saw wave W_{SAW3}. The charge switch 723 and the discharge switch 724 are controlled by the outputs of the delay cell 780. The voltage generator 740 is coupled to the waveform generator 720 and the comparator 760, and used for generating a fixed upper reference voltage VH3 and a fixed lower variable reference voltage VL3. The inputs of the comparator 760 are coupled to the voltage generator 740 and the waveform generator 720. The comparator 760 compares the saw wave W_{SAW3} with the upper reference voltage VH3 and the lower reference voltage VL3 and generates a comparison result T2. The output of the comparator 760 is coupled to the delay cell 780. The comparator 760 outputs the comparison result T2 to the delay cell 780. The delay cell 780 is coupled to the comparator 760, and used for generating the output signal OSC_OUT by delaying the comparison result T2 for a delay time T_{d2} according to the feedback voltage V_{FB}. Then, the output signals OSC_OUT and OSC_OUT′ are fed back to the waveform generator 720. The output signal OSC_OUT conducts the charge switch 723 and charges the capacitor C4 for the delay time T_{d2}. This holds the saw wave W_{SAW3} at a maximum voltage for the delay time T_{d2} until the charge switch 723 is off and the output signal OSC_OUT′ conducts the discharge switch 724 to discharge the capacitor C4, and therefore increases the period of the output signal OSC_OUT. Accordingly, the frequency of the output signal OSC_OUT is decreased. Since the feedback voltage V_{FB} can reflect the load condition, this may imply that the adjustable frequency generator 70 may vary the delay time T_{d2} with the load condition. When the load 110 becomes lighter or is removed, the delay time T_{d2} is increased accordingly. This makes the frequency of the output signal OSC_OUT be decreased. Please refer to FIG. 8, which illustrates various signal waveforms of the adjustable frequency generator 70. As shown in FIG. 8, when the delay time T_{d2} increases, the frequency of the output signal OSC_OUT decreases. When the delay time T_{d2} is 0, the frequency of the output signal OSC_OUT is not changed. Please note that charging the capacitor C4 and holding the saw wave W_{SAW3} at the maximum voltage for the delay time T_{d2} may imply increasing of the rising time of the saw wave W_{SAW3}, which may be achieved by the adjustable frequency generator 30 as well. Merely, the adjustable frequency generator 30 increase the rising time of the saw wave W_{SAW1} by adjusting the capacitance of the capacitor C2. Please refer to FIG. 8, which illustrates various signal waveforms of the adjustable frequency generator 70 or the adjustable frequency generator 30. As shown in FIG. 8, when the delay time T_{d2} increases, the frequency of the output signal OSC_OUT decreases. When the delay time T_{d2} is 0, the frequency of the output signal OSC_OUT is not changed.

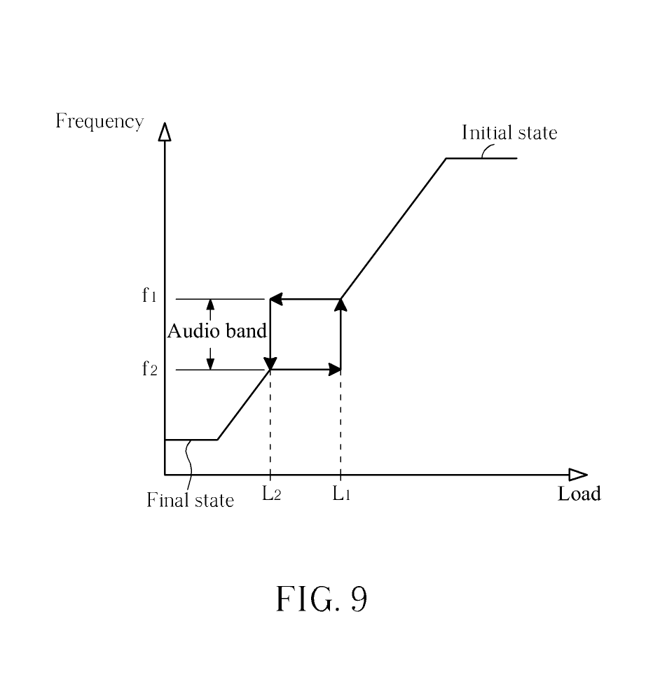

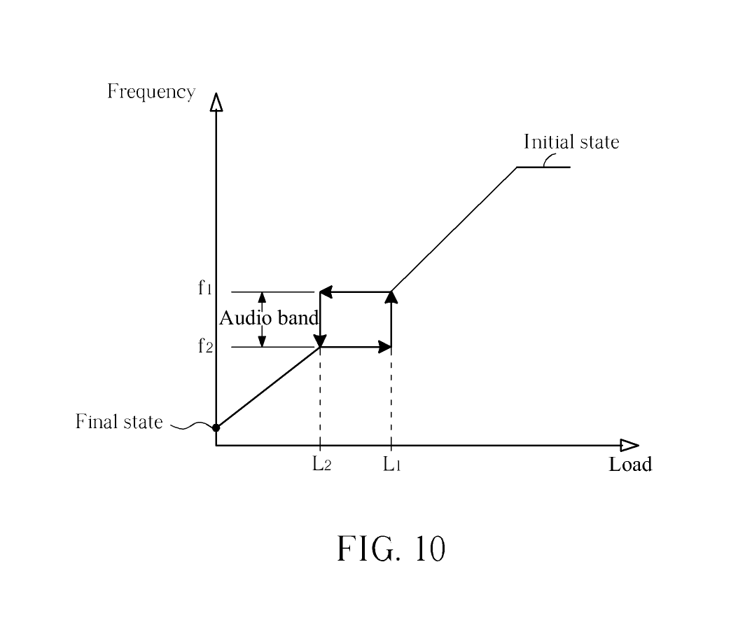

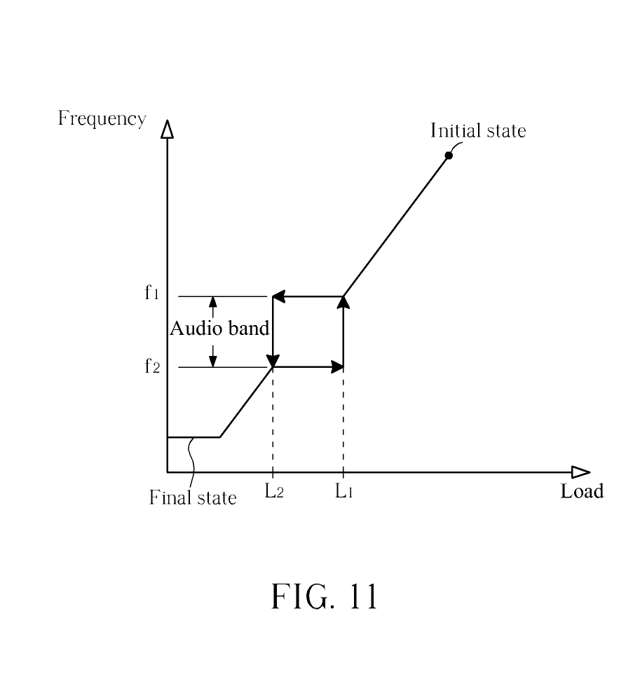

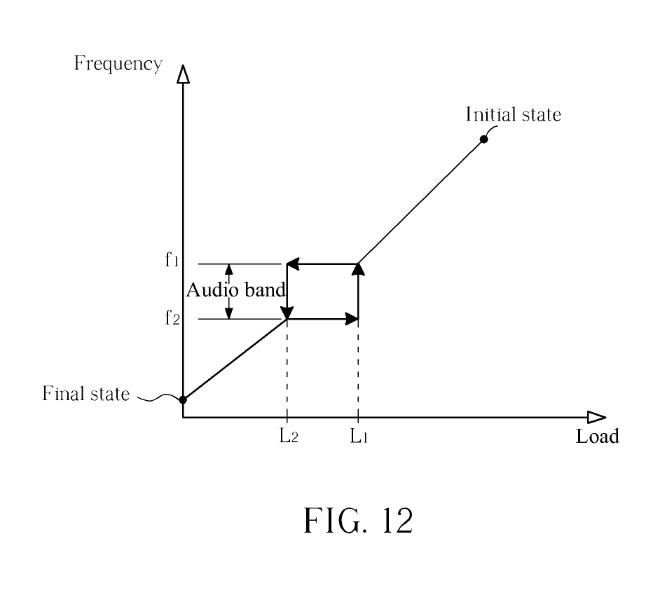

Please refer to FIG. 9, which illustrates a load versus a frequency (e.g. frequency of the output signal OSC_OUT). To begin with, the load and the frequency are at an initial state. Then, the load starts to drop. When the load reaches the load L1, the frequency is at the frequency f1. When the load goes below the load L1, the frequency stays still at the frequency f1 until the load descends to the load L2. At the moment the load going a little lower than the load L2, the frequency drops directly from the frequency f1 to the frequency f2. Then, if the load keeps going down, the frequency is proportional to the load. Eventually, the frequency and the load go to a final state. When the load increases from the final state before reaching the load L2, the load is proportional to the frequency. When the load reaches the load L2, the frequency is at the frequency f2. If the load goes above the load L2, the frequency stays still at the frequency f2 until the load meets the load L1. At the moment the load going a little higher than the load L1, the frequency jumps up to the frequency f1. If the load keeps going up, the frequency is proportional to the load and return to the initial state. The sharp frequency dropping and rising may be referred as to an audio band. Basically, the audio band is the humanly audible frequency (e.g. from hundred hertz to 20K Hz). As a result, when the load increases or decrease, the power supply may avoid operating at a range of the audio band (e.g. from hundred hertz to 20K Hz). The absence of the audio band may reduce the humanly audible noise generated by the power supply. In the initial state shown in FIG. 9, the frequency remains a steady high frequency regardless of the increasing of the load. In the final state shown in FIG. 9, the frequency remains a steady low frequency regardless of the decreasing the load. In some examples, the initial state and the final state may differ according to different examples. Please refer to FIGS. 10-12, which illustrates loads versus frequencies according to different examples. In the initial state shown in FIG. 10, the frequency remains a steady high frequency regardless of the increasing of the load. In FIG. 10, the final state denotes the frequency having an initial value when zero load. In the initial state shown in FIG. 11, the frequency and the load may be any point above the load L1 and frequency f1. The frequency is just proportional to the load. In the final state shown in FIG. 11, the frequency remains the steady low frequency regardless of the decreasing of the load. In the initial state shown in FIG. 12, the frequency and the load may be any point above the load L1 and frequency f1. In FIG. 12, the final state denotes the frequency having an initial value when zero load.

Thus, the present invention mainly provides an adjustable frequency generator capable of adjusting output frequency according to the load condition. The adjustable frequency generator comprises the variable capacitor, which is inversely proportional to the load. When the capacitance of the variable capacitor is increased, the output frequency of the adjustable frequency generator is decreased. That is, the output frequency of the adjustable frequency generator is decreased at the light load or no load.

Moreover, the present invention provides an adjustable frequency generator capable of adjusting output frequency according to the load condition. The adjustable frequency generator comprises the voltage generator. The voltage generator can generate a variable upper reference voltage and a variable lower reference voltage. The difference of the variable upper reference voltage and the variable lower reference voltage is inversely proportional to the load. When the difference of the variable upper reference voltage and the variable lower reference voltage is increased, the output frequency is decreased. That is, the output frequency of the adjustable frequency generator is decreased at the light load or no load.

To sum up, the aforementioned examples adjusts a variable capacitor or variable upper and lower reference voltages in accordance with the load condition to provide a adjustable frequency signal. When the load is light or removed, the PWM controller can operate at a lower operation frequency such that the switching losses can be reduced and the efficiency of the power supply can be improved. A design adopting both variable capacitor and variable upper/lower reference voltages may be another way, operation principle of which can be derived from the aforementioned examples.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An adjustable frequency generator for a power supply, the adjustable frequency generator comprising:
a waveform generator for generating a saw wave;
a voltage generator for generating a variable upper reference voltage and a variable lower reference voltage according to variation of a load;
a comparator coupled to the waveform generator and the voltage generator, for comparing the saw wave with the variable upper reference voltage and the variable lower reference voltage and generating an output signal, wherein a frequency of the output signal decreases when the load becomes lighter.

2. The adjustable frequency generator of claim 1, wherein the waveform generator comprises:
a first current source for providing a charge current;
a second current source for providing a discharge current;
an inverter for inverting the output signal and generating an inverted output signal;
a charge switch coupled to the first current source, for turning on/off according to the output signal;
a discharge switch coupled to the second current source and the inverter, for turning on/off according to the inverted output signal; and
a capacitor coupled to the charge switch and the discharge switch, for storing or releasing electrical charges to generate the saw wave.

3. The adjustable frequency generator of claim 1, wherein the difference between the variable upper reference voltage and the variable lower reference voltage increases when the load become lighter.

4. The adjustable frequency generator of claim 1, wherein the frequency of the output signal remains at a first frequency when the load is between a first value and a second value, and the frequency of the output signal drops down to a second frequency when the load is less than the second value, wherein the first value is greater than the second value and the first frequency is higher than the second frequency.

5. The adjustable frequency generator of claim 1, wherein the frequency of the output signal remains at a first frequency when the load is between a first value and a second value, and the frequency of the output signal jump up to a second frequency when the load is greater than the second value, wherein the first value is less than the second value and the first frequency is lower than the second frequency.

6. An adjustable frequency generator for a power supply, the adjustable frequency generator comprising:
a waveform generator for generating a saw wave according to variation of a load of the power supply, the waveform generator comprising:
a variable capacitor for adjusting capacitance of the variable capacitor according to the variation of the load and storing or releasing electrical charges to generate the saw wave;
a voltage generator for generating a upper reference voltage and a lower reference voltage;
a comparator coupled to the waveform generator and the voltage generator, for comparing the saw wave with the upper reference voltage and the lower reference voltage and generating an output signal, wherein a frequency of the output signal decreases when the load becomes lighter.

7. The adjustable frequency generator of claim 6, wherein the waveform generator further comprises:
a first current source for providing a charge current;
a second current source for providing a discharge current;
an inverter for inverting the output signal and generating an inverted output signal;
a charge switch coupled to the first current source, for turning on/off according to the output signal; and
a discharge switch coupled to the second current source and the inverter, for turning on/off according to the inverted output signal.

8. The adjustable frequency generator of claim 6, wherein the capacitance of the variable capacitor increases when the load become lighter.

9. The adjustable frequency generator of claim 6, wherein the frequency of the output signal remains at a first frequency when the load is between a first value and a second value, and the frequency of the output signal drops down to a second frequency when the load is less than the second value, wherein the first value is greater than the second value and the first frequency is higher than the second frequency.

10. The adjustable frequency generator of claim 6, wherein the frequency of the output signal remains at a first frequency when the load is between a first value and a second value, and the frequency of the output signal jump up to a second frequency when the load is greater than the second value, wherein the first value is less than the second value and the first frequency is lower than the second frequency.

11. An adjustable frequency generator for a power supply, the adjustable frequency generator comprising:
a waveform generator for generating a saw wave, the waveform generator comprising:
a first current source for providing a charge current;
a second current source for providing a discharge current;
a charge switch coupled to the first current source, for turning on/off according to the output signal;
a discharge switch coupled to the second current source and the inverter, for turning on/off according to the inverted output signal; and
a capacitor coupled to the charge switch and the discharge switch, for storing or releasing electrical charges to generate the saw wave;
a voltage generator for generating an upper reference voltage and a lower reference voltage;
a comparator coupled to the waveform generator and the voltage generator, for comparing the saw wave with the upper reference voltage and the lower reference voltage and generating a comparison result; and
a delay unit coupled to the comparator for delaying a period of the comparison result a delay time according to variation of a load of the power supply to generate an output signal;
wherein a frequency of the output signal decreases when the load becomes lighter.

12. The adjustable frequency generator of claim 11, wherein the delay time is prolonged longer when the load become lighter.

13. The adjustable frequency generator of claim 6, wherein the frequency of the output signal remains at a first frequency when the load is between a first value and a second value, and the frequency of the output signal drops down to a second frequency when the load is less than the second value, wherein the first value is greater than the second value and the first frequency is higher than the second frequency.

14. The adjustable frequency generator of claim 6, wherein the frequency of the output signal remains at a first frequency when the load is between a first value and a second value, and the frequency of the output signal jump up to a second frequency when the load is greater than the second value, wherein the first value is less than the second value and the first frequency is lower than the second frequency.

15. A power supply comprising:
a load;
a transformer comprising:
a primary winding for generating a feedback signal in response to variation of the load; and
a secondary winding coupled to the load, for providing an output current;
a pulse width modulation (PWM) controller coupled to the primary winding, for controlling the output current according to the feedback signal; and
an adjustable frequency generator coupled to the PWM controller, for generating an output signal to the PWM controller according to the feedback signal;
wherein a frequency of the output signal decreases when the load becomes lighter.

16. The power supply of claim 15, wherein the adjustable frequency generator comprising:
a waveform generator for generating a saw wave, the waveform generator comprising:
a first current source for providing a charge current;
a second current source for providing a discharge current;
an inverter for inverting the output signal and generating an inverted output signal;
a charge switch coupled to the first current source, for turning on/off according to the output signal;
a discharge switch coupled to the second current source and the inverter, for turning on/off according to the inverted output signal; and
a capacitor coupled to the charge switch and the discharge switch, for storing or releasing electrical charges to generate the saw wave;
a voltage generator for generating a variable upper reference voltage and a variable lower reference voltage according to the feedback; and
a comparator coupled to the waveform generator and the voltage generator, for comparing the saw wave with the variable upper reference voltage and the variable lower reference voltage and generating an output signal.

17. The power supply of claim 16, wherein the difference between the variable upper reference voltage and the variable lower reference voltage increases when the load become lighter.

18. The power supply of claim 15, the adjustable frequency generator comprising:
a waveform generator for generating a saw wave according to the feedback signal, the waveform generator comprising:
a first current source for providing a charge current;
a second current source for providing a discharge current;
an inverter for inverting the output signal and generating an inverted output signal;
a charge switch coupled to the first current source, for turning on/off according to the output signal; and
a discharge switch coupled to the second current source and the inverter, for turning on/off according to the inverted output signal
a variable capacitor coupled to the charge switch and the discharge switch, for adjusting capacitance of the variable capacitor according to the feedback signal and storing or releasing electrical charges to generate the saw wave;
a voltage generator for generating an upper reference voltage and a lower reference voltage;
a comparator coupled to the waveform generator and the voltage generator, for comparing the saw wave with the upper reference voltage and the lower reference voltage and generating an output signal.

19. The power supply of claim 15, wherein the capacitance of the variable capacitor increases when the load become lighter.

20. The power supply of claim 15, wherein the adjustable frequency generator comprises:
a waveform generator for generating a saw wave, the waveform generator comprising:
a first current source for providing a charge current;
a second current source for providing a discharge current;
a charge switch coupled to the first current source, for turning on/off according to the output signal;
a discharge switch coupled to the second current source and the inverter, for turning on/off according to the inverted output signal; and
a capacitor coupled to the charge switch and the discharge switch, for storing or releasing electrical charges to generate the saw wave;
a voltage generator for generating an upper reference voltage and a lower reference voltage;
a comparator coupled to the waveform generator and the voltage generator, for comparing the saw wave with the upper reference voltage and the lower reference voltage and generating a comparison result; and
a delay unit coupled to the comparator for delaying a period of the comparison result a delay time according to variation of a load of the power supply to generate an output signal.

21. The power supply of claim 20, wherein the delay time is prolonged longer when the load become lighter.

22. The power supply of claim 15, wherein the frequency of the output signal remains at a first frequency when the load is between a first value and a second value, and the frequency of the output signal drops down to a second frequency when the load is less than the second value, wherein the first value is greater than the second value and the first frequency is higher than the second frequency.

23. The power supply of claim 15, wherein the frequency of the output signal remains at a first frequency when the load is between a first value and a second value, and the frequency of the output signal jump up to a second frequency when the load is greater than the second value, wherein the first value is less than the second value and the first frequency is lower than the second frequency.
